(19) United States
(12) Patent Application Publication
(10) Pub. No.: US 2010/0125659 A1
(43) Pub. Date: May 20, 2010

(54) Method and Apparatus Regarding the Automatic Transmission of Operational State Event and Time Information

(75) Inventor: Thomas J. Schlangen, Gilbert, AZ (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/273,207

(22) Filed: Nov. 18, 2008

(51) Int. Cl. G06F 15/173

(52) U.S. Cl. 709/224

(57) ABSTRACT

A network element (300), upon determining (101) that an operational state event (such as a significant configuration change, a significant fault event, or the like) has occurred, can automatically transmit (102) a message to a peer network element. This message can provide information regarding the operational state event coupled with information regarding a time that corresponds to when the operational state event occurred. By one approach, this message can further comprise one or more of identification information that uniquely identifies the network element, a registration address by which a receiving element can register with the network element, and a loading indicator. Such a message can be transmitted essentially contemporaneously with the aforementioned determination that the operational state event has occurred or at some later time. A network element that receives (201) such a message can, in turn, responsively take (202) a corresponding predetermined automated action such as by re-registering with the transmitting element.

### TECHNICAL FIELD

This invention relates generally to communications networks and more particularly to automated transmission activities as pertain to the administration of such a network.

### BACKGROUND

Modem communications networks are often comprised of a large number of varying network elements. Common examples in this regard can easily range from hundreds to tens or even hundreds of thousands of varying network elements (such as, but not limited to, servers as are known in the art) as may comprise, for example, the infrastructure of such a network. In most application settings, many (or even all) of these network elements must be provisioned with a variety of items of information that facilitate the compatible interaction of each network element with other network elements as comprise a given network. It is well accepted that manually provisioning thousands of network elements comprises both a tedious and an error-prone process.

Accordingly, it is known to employ automated provisioning to attempt to reduce human involvement and thereby address such issues. In a typical application setting, such automated provisioning relies upon a central authority (such as a network element manager). This approach, however, can lead to increased operational support expenses and even reduced overall network resources availability.

Certain peer-to-peer approaches have also been suggested to generally address at least elements of such a need. Generally speaking, however, these approaches, too, have often given rise to their own corresponding problems. Such problems can include, but are certainly not limited to, a lack of timeliness (which can lead to significant loading problems), considerable bandwidth insensitivity, undue complexity, and so forth. In particular, for example, it can require a given network element in a large network to individually contact thousands of peer platforms in order to effect the dissemination of such information. Such an approach can also raise the issue of how to handle failure cases. That is, what should be done when either an initial or a subsequent attempt to contact a peer is unsuccessful?

### BRIEF DESCRIPTION OF THE DRAWINGS

The above needs are at least partially met through provision of the method and apparatus regarding the automatic transmission of operational state event and time information described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to many of these various embodiments, a network element, upon determining that an operational state event as pertains to that network element has occurred can automatically transmit (via a network that is coupled to that network element) a message to intended peer network elements. This message can provide information regarding the operational state event coupled with information regarding a time that corresponds to when the operational state event occurred. Exemplary events as may comprise such an operational state event include significant configuration changes, significant fault events, and so forth. The information regarding time can comprise, for example, a timestamp that represents a date, a time of day, or both.

By one approach, this message can further comprise one or more of identification information that uniquely identifies the network element, a registration address by which a peer network element comprising a receiving element can register with the network element, and a loading indicator. Such a message can be transmitted essentially contemporaneously with the aforementioned determination that the operational state event has occurred or at some later time (such as during a regularly scheduled periodic transmission).

A network element that receives such a message can, in turn, responsively take a corresponding predetermined automated action. As one simple example in this regard, this might comprise automatically interacting with the transmitting network element (such as by re-registering therewith).

So configured, information regarding important state events can be quickly and timely broadcast to thereby permit receiving elements to be apprised of the event and to take a corresponding responsive action when and as appropriate. This, in turn, can help considerably with respect to load management issues. As but one example in this regard, these teachings can aid in avoiding the kinds of network loading issues that tend to characterize the use of existing individual unicasting-based peer specific messages. In such a case, not only does the network element benefit, but the routing network also benefits due to an overall reduction in traffic (with those skilled in the art recognizing that although replication of a broadcast/multicast message occurs at various points throughout the network, the overall network traffic is nevertheless reduced significantly).

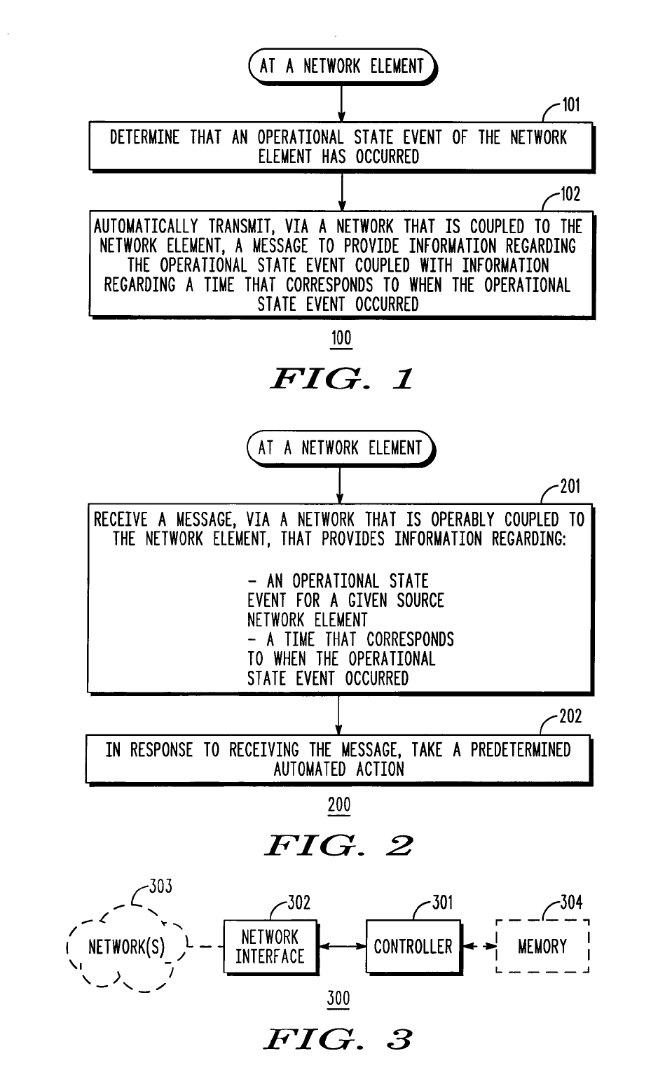

These and other benefits may become clearer upon making a thorough review and study of the following detailed description. Referring now to the drawings, and in particular to FIG. 1, an illustrative process that is compatible with many of these teachings will now be presented. This process 100 can be carried out by a network element of choice. A prime example in this regard would comprise a typical modern infrastructure element such as a server. Those skilled in the art will recognize, however, that such a process 100 can be carried out by various other network elements including but not limited to edge devices such as wireless and wired client platforms.

This process 100 provides a step 101 of determining that an operational state event of the network element has occurred. In a typical application setting this will likely comprise an act of self discovery. These teachings will accommodate, however, an application setting that provides an external mechanism to detect such an event and to convey information regarding that detection to the network element that has experienced the event. There are various known ways by which such an event can be detected. As these teachings are not overly sensitive to any particular selection in this regard, for the sake of brevity and the preservation of clarity, further elaboration in this regard will not be presented here.

Generally speaking, this step 101 occurs more or less in real time. While there may be application settings where a delay of a few minutes (such as, for example five or ten minutes) may be acceptable, in most cases it will likely be preferable that this determination occur as soon as is practical once the operational state event has occurred (or has at least matured to a point of reliable detectablity).

These teachings will accommodate the detection of a variety of operational state events. Generally speaking, this process 100 works well with operational state events that are of a kind and nature that are likely to prompt at least a momentary significant deterioration or stoppage of network-based services to one or more other network elements. As used herein, this reference to “momentary” will be understood to refer to a duration of time that is considerable in the context of the application setting such that the reduced or denied level of service will persist at least long enough to likely cause a served peer network element to seek an alternative source for the delayed/denied service(s).

As a first useful example in these regards, the operational state event can comprise a significant configuration change as pertains to the network element. As used herein, such references to “significant” will be understood to refer to a degree of change that will render prior configuration-based information as has been previously provisioned to a served peer network element non-useful with respect to now receiving the corresponding service being provided by the network element that has experienced the significant configuration change. Some examples of an exemplary configuration change might include, but are not limited to: (1) A change in total available capacity (for example, where server hardware has been added, removed, replaced, or the like, and this relates to a change in available capacity such that receivers of this information will need to adjust their server selection method accordingly); (2) A change in capabilities (for example, when a feature or function has been added, removed, changed, or the like, which enables and/or requires the peers to use the server differently such that receivers will need to know what features and functions are now available at this server); and (3) A change in scope or location (for example, where a server has changed its scope of service by including and/or excluding certain portions of the network such that receivers will need to know whether the server has been added to or removed from their service area).

As a second useful example in these regards, the operational state event can comprise a significant fault event as pertains to the network element (where “significant” will be understood to refer to a degree of change that will render prior information as has been previously provisioned by the network element to a served network element non-useful with respect to now receiving the corresponding service being provided by the network element that has experienced the significant fault event). Some examples of illustrative fault conditions include, but are not limited to: (1) A platform reset (for example, when the server has gone completely offline and has recently recovered, receivers need to know that the services that were established with the server prior to the “fault timestamp” are no longer supported by the server, which may cause the receiver to deallocate services and/or resources that were associated with this server before it failed; such services and/or resources are sometimes referred to as having been orphaned); (2) A device fault (this is essentially a subset of the previous item; for example, a server platform may be comprised of several components where if one of those components fails, then services provided by that component have been orphaned, and the receivers may need to react as described above); (3) A lost capability (somewhat as above, the server may detect a fault, internal or external, that has disabled its ability to provide a set of features or functions; for example, when communication with an external network has been lost, the server can no longer provide services that were unique to that external network and the receiver needs to know that such services are not available through this server).

Those skilled in the art will recognize that for a given network element the operational state event can comprise either a significant configuration change or a significant fault event. It will also be recognized that an operational state event could comprise both such conditions if desired. Those skilled in the art will recognize and understand that the specifics of these examples serve an illustrative purpose only and are not offered with any suggestion or intent that these specifics comprise an exhaustive listing of all such possibilities in this regard.

This process 100 then provides the step 102 of automatically transmitting (via, for example, a network that is coupled to the network element) a message. This message provides information regarding the detected operational state event coupled with information regarding a time that corresponds to when the operational state event occurred. By one approach, this transmission can occur as soon as is practical following detection of the instigating operational state event. These teachings will also accommodate, however, effecting this transmission during a subsequent regularly scheduled periodic transmission. The latter approach may be useful, for example, in application settings where the network element offers a regular and periodic broadcast every five, ten, or fifteen minutes (those skilled in the art recognizing that these durations are illustrative in nature and that the periodicity can be essentially any desired length, as can the duration of the transmission itself).

The aforementioned information regarding time can comprise, by one approach, a timestamp. In such a case, and as one example in these regards, the timestamp can include both a date and a time of day. This information regarding time can comprise a time when the operational state event began and/or when this event concluded and/or was otherwise remedied.

This message can also contain other information if desired. As one specific example in this regard, the message can further include identification information that uniquely identifies the network element. In a typical modern application setting, for example, this identification information might comprise a Uniform Resource Locator (URL) or Uniform Resource Identifier (URI). Those skilled in the art will recognize that numerous other possibilities exist in these regards (such as, but not limited to, an Internet Protocol address, a Domain Name System (DNS) address, a 3GPP Globally Unique MME Identifier (GUMMEI), or a Fully Defined Name (such as BTS-3-2-478, where “BTS” is a type of network element and the hyphenated numbers are assigned, for example, by the equipment operator), depending upon the characterizing attributes of a given application setting.

As another example, this message can further include information comprising a registration address by which a receiving element can register with the network element. This might comprise, for example, providing an Internet Protocol address or a DNS address and optionally including a port number for the form, for example, 130.6.23.129:2135 or serviceproviderserverXYZ.com:2135 or the like though again a URL or a URI will suffice for these purposes if desired.

As yet another example in these regards, this message can further include a loading indicator. Various loading indicators are known in the art and they tend to vary with the specifics of the application setting. Generally speaking, however, such indicators serve to indicate a degree (either directly or indirectly) to which a given network element is presently available to provide services to another element. In particular those skilled in the art will recognize that loading indicators can be used by peer network elements to balance the offered load evenly across the system. A well-balanced system operates more efficiently and it also reduces the probability that any of the network equipment will be forced into an overload condition. Similarly, loading indicators enable the system to reach a well-balanced state quickly when capacity is added to or removed from the system.

By one approach, such a message can include all three of the aforementioned specific categories of information. Such an approach, in fact, may be particularly appropriate for many modern application settings. Those skilled in the art will also recognize that these specific examples are provided by way of illustration and without an intention of suggesting any particular limitation in these regards.

Referring now to FIG. 2, a receiving network element can effect a corresponding process 200. By one approach, this process 200 can include the step 201 of receiving the aforementioned message that provides the information regarding the operational state event for a given source network element along with information regarding a time that corresponds to when this operational state event occurred. This message will typically be received via a network that is operably coupled to this receiving network element.

This process 200 also provides the step 202 of taking a predetermined automatic action (or actions as the case may be) in response to receiving the aforementioned message. By one approach, this automatic action can comprise automatically interacting with the given source network element that transmitted the message. Such an interaction might comprise, for example, re-registering with the given source network element. Such re-registration can occur, for example, as an immediate response or can be delayed to fit within the scheduling opportunities provided via some periodic maintenance protocol being observed by the receiving network element. Such a registration can also be delayed by a random period of time if desired in order to avoid a spike of registrations at the sender (for example, upon receipt of a message indicating a configuration change, wait a random length of time between 0 and 30 seconds (or some other time as reasonably corresponds to a given server's capacity to accommodate and process registrations and/or other applicable quality of service requirements), and then register with the sender)

Numerous other possibilities exist in these regards, of course. For example, as noted above, the message can include, if desired, a loading indicator. When true, the receiving network element can automatically feed that loading indicator into a load balancing algorithm of choice. Numerous such algorithms are known in the art and typically serve to alter the probability of selecting a particular server in order to balance the server load across a pool of available servers. By this approach, the loading indicator can serve to update the receiving network element's employment of such a load balancing algorithm.

As another example, when the message comprises, at least in part, information regarding a significant configuration change, the receiving network element can automatically compare the timestamp information in the message with the corresponding time information for the receiving network element's local copy of configuration information for this particular source network element. When the receiving timestamp is more recent than that time that corresponds to the local copy, the receiving network element can automatically re-register with the source network element in order to receive updated configuration information.

As yet another example, when the message comprises, at least in part, information regarding a significant fault event, the receiving network element can automatically compare the message's timestamp with the time information as corresponds to locally available information for this source network element. When the received timestamp is more recent than the local copy's time information, the receiving network element can take an appropriate corresponding action. This might comprise, for example, re-registering with the serving network element. This may also comprise, depending upon the application setting, reclaiming orphaned resources, releasing impacted client sessions, and so forth.

As noted above, such a message can be transmitted more or less in real time in response to detecting a triggering event. It is also possible, however, and also as is noted above, to delay the transmissions of such messages to coincide with some regularly scheduled periodic transmissions. It would also be possible, of course, to use both of these approaches. In that case, the message would be sent as soon as practicable upon detecting the instigating event and also later during some regularly scheduled and periodic transmission opportunity.

Those skilled in the art will recognize that periodic transmissions offer a number of possible benefits. For example, such an approach may improve overall reliability. This is especially true if the message is re-broadcast during a number of consecutive periodic opportunities. So long as the information being transmitted is not highly time sensitive, the use of highly reliable transport mechanisms (such as TCP, SCTP, SRM, and the like) can be eschewed in favor of a number of re-transmissions of the message information at various periodic opportunities.

Using periodic transmissions may also serve to avoid the need to use polling techniques by which network elements might poll the source network element in order to obtain the latter's status. In a large network, such polling can and will consume considerable resources and can impose a significant impact on system performance. Periodic multicasts (or broadcasts) of such a message, however, tends to use little in the way of network resources.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment, a network element 300 capable of serving as either the source network element or the receiving network element described above can comprise a controller 301 that operably couples to a network interface 302 that serves to provide access to one or more networks 303 to facilitate the aforementioned message transmissions and receptions. Those skilled in the art will recognize and appreciate that such a controller 301 can comprise a fixed-purpose hard-wired platform or can comprise a partially or wholly programmable platform. All of these architectural options are well known and understood in the art and require no further description here.

This controller 301 can be configured (using, for example, corresponding programming as will be well understood by those skilled in the art) to carry out one or more of the aforementioned steps, actions, and/or functionality. The instructions comprising such programming can be locally stored in the controller 301 when the latter has appropriate resources in this regard and/or can be wholly or partially stored in a memory 304 that operably couples to the controller 301. It will also be understood that the memory component shown can comprise a plurality of memory elements or can be comprised of a single memory element (as is suggested by the illustration).

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize and appreciate that these teachings provide a relatively simple yet highly effective mechanism for ensuring that various network elements remain usefully apprised of timely information regarding network element events that can affect subsequent network usability and latency. These teachings are highly scalable and in fact may tend to be more useful as the size and complexity of a given network grows. It will also be appreciated that these teachings are readily implemented in highly cost effective ways.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
at a network element:
determining that an operational state event of the network element has occurred;
automatically transmitting, via a network that is coupled to the network element, a message intended for peer network elements to provide information regarding the operational state event coupled with information regarding a time that corresponds to when the operational state event occurred.

2. The method of claim 1 wherein the operational state event comprises at least one of:
a significant configuration change;
a significant fault event.

3. The method of claim 2 wherein the operational state event comprises either of:
a significant configuration change;
a significant fault event.

4. The method of claim 1 wherein the information regarding a time comprises a timestamp.

5. The method of claim 4 wherein the timestamp includes both a date and a time of day.

6. The method of claim 1 wherein the message further comprises at least one of:
identification information that uniquely identifies the network element;
a registration address by which a receiving element can register with the network element;
a loading indicator.

7. The method of claim 6 wherein the message comprises each of:
identification information that uniquely identifies the network element;
a registration address by which a receiving element can register with the network element;
a loading indicator.

8. The method of claim 1 wherein automatically transmitting the message comprises transmitting the message during a regularly scheduled periodic transmission.

9. A network element comprising:
a network interface;
a controller that is operably coupled to the network interface and that is configured to:
determine that an operational state event of the network element has occurred;
automatically transmit, via the network interface, a message intended for peer network elements to provide information regarding the operational state event coupled with information regarding a time that corresponds to when the operational state event occurred.

10. The network element of claim 9 wherein the operational state event comprises at least one of:
a significant configuration change;
a significant fault event.

11. The network element of claim 10 wherein the operational state event comprises either of:
a significant configuration change;
a significant fault event.

12. The network element of claim 9 wherein the information regarding a time comprises a timestamp.

13. The network element of claim 12 wherein the timestamp includes both a date and a time of day.

14. The network element of claim 9 wherein the message further comprises at least one of:
identification information that uniquely identifies the network element;
a registration address by which a receiving element can register with the network element;
a loading indicator.

15. The network element of claim 14 wherein the message comprises each of:
identification information that uniquely identifies the network element;
a registration address by which a receiving element can register with the network element;
a loading indicator.

16. A method comprising:
at a peer network element:
receiving a message, via a network that is operably coupled to the peer network element, that provides information regarding:
an operational state event for a given source network element;
a time that corresponds to when the operational state event occurred.
in response to receiving the message, taking a predetermined automated action.

17. The method of claim 16 wherein the operational state event comprises at least one of:
a significant configuration change;
a significant fault event.

18. The method of claim 16 wherein the information regarding a time comprises a timestamp.

19. The method of claim 16 wherein the message further comprises at least one of:
identification information that uniquely identifies the given source network element;
a registration address by which a receiving element can register with the given source network element;
a loading indicator.

20. The method of claim 16 wherein the predetermined automated action comprises automatically interacting with the given source network element.

21. The method of claim 20 wherein automatically interacting with the given source network element comprises, at least in part, re-registering with the given source network element.
